(19) United States
(12) Patent Application Publication
(10) Pub. No.: US 2007/0286408 A1
(43) Pub. Date: Dec. 13, 2007

(54) Module and Connector

(76) Inventors: Didier Lecomte, Cavaillon (FR); Patrick Prel, Mery Sur Oise (FR)

Correspondence Address: SOFER & HAROUN LLP., 317 MADISON AVENUE, SUITE 910, NEW YORK, NY, 10017, US

(21) Appl. No.: 10/581,919

(22) PCT Filed: Dec. 8, 2004
(86) PCT No.: PCT/FR04/50664

§ 371 Date: Apr. 19, 2007

(30) Foreign Application Priority Data
Dec. 9, 2003 (FR) 0351007

(51) Int. Cl. H04Q 1/02

(52) U.S. Cl. 379/413.04

(57) ABSTRACT

The invention relates to a connector module (100) which is used for telephone transmissions, more particularly adapted to transmissions on ADSL subscriber lines. The module (100) comprises a housing (108) including two parallel rows—(R1) and (R2)—of contacts facing each other, whereby each of said contacts comprises a first terminal part (106) for connection to a conductor and an opposite second terminal part (107), two successive contacts of a same row defining a pair of contacts, wherein each of said second terminal parts (107) normally rests elastically against the second terminal part (107) opposite. The module (100) also comprises a detachable card (104) for electrical connection and lowpass filtering of signals transmitted between the second terminal parts of at least one pair of contacts of a row, i.e. first pair, and said second terminal parts of at least one pair of contacts on the other row, i.e. second pair, whereby the detachable card (104) comprises connection elements on each of the surfaces thereof, said connection elements establishing a connection between the opposite second terminal parts of each row by moving apart the second terminal parts which are normally in contact.

The present invention relates to a connector module which is used for telephone transmissions, more particularly adapted to transmissions on asymmetric digital subscriber lines (ADSL). The present invention also relates to a connector strip for forming distribution frames, incorporating such modules and notably intended for making the connection between copper pairs of a multi-pair cable and jumpers.

Generally, ADSL technology enables the conventional telephone copper pair to be used for telephone and high data-rate Internet connection simultaneously. For this, it makes the most out of telephone line frequencies which have remained unused up to now (frequencies higher than 4,000 Hz); thus, the telephone uses the low frequencies and the high data rate connection uses the high frequencies, by means of an ADSL modem installed at the user: ADSL technology therefore provides a permanent Internet connection and independent of the use made of the telephone.

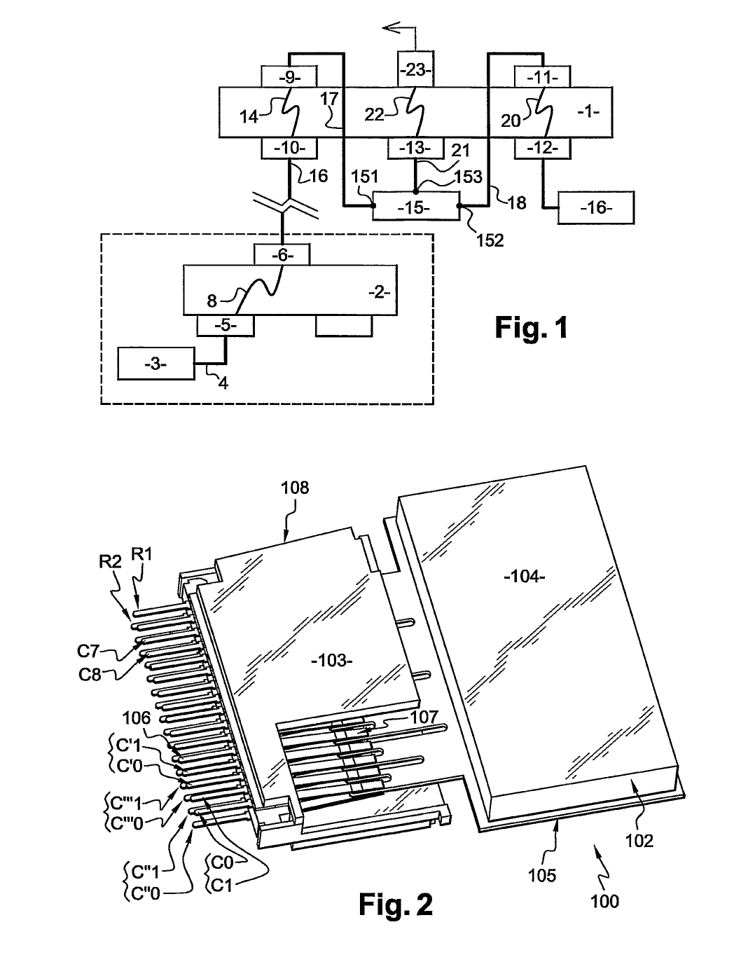

In order to provide an ADSL connection to its clients, one of the solutions available to an alternative operator is to resort to partial unbundling of the line. In this case, at the frame of the historical operator, France Telecom, with a filter connected on the relevant line, the low frequencies, over which voice is transmitted, may be directed towards the telephone network of France Telecom, and the high frequencies over which the data are transmitted, may be directed towards the network of the operator providing the Internet connection. Such an architecture is illustrated in FIG. 1.

Frame 1 refers to the frame of the historical operator and frame 2 refers to the frame of an alternative operator. Frame 1 includes five connector strips 9-13 and a connector 23, and frame 2 includes two connector strips 5 and 6. Each of these connector strips comprises a plurality of connector modules not shown, usually 16 modules, and is generally assigned to a cable with 128 copper pairs. The digital subscriber line access multiplexer (DSLAM) equipment 3 of the alternative operator combines several digital subscriber lines (DSL) in order to connect them to the strip 5 of the frame 2 of the alternative operator via a cable 4. Internet type digital data come in and arrive from the DSLAM 3. With a jumper 8, the strip 5 may be connected to the strip 6. A cable 16 (the intermediate cut designating the boundary between the alternative operator and the historical operator) is connected to the strip 10 of the frame 1 of the historical operator. A jumper 14 connects the strip 10 to the strip 9. The strip 9 is connected to a first input 151 of a filtering rack 15 via a cable 17. More specifically, the filtering rack 15 is a rack including different ADSL filters not shown.

In the same way as for the incoming digital data arriving from the DSLAM, incoming digital voice data arriving from the subscriber connection unit (SCU) 16 will pass through the filtering rack 15 via a second input 152. The SCU 16 is thus connected to the strip 12 of the frame 1 via a cable 19. The strip 12 is connected to the strip 11 via a jumper 20 and the strip 11 is connected to the second input 152 of the filtering rack 15 via a cable 18.

The output 153 of the filtering rack 15 is connected through a cable 21 to the strip 13, which is connected via a jumper 22 to a connection 23 towards a copper pair connected to the final client.

Therefore, with the filtering rack 15, the low frequencies over which pass the voice data, may be directed towards and away from the SCU 16 and the high frequencies, over which pass the Internet type digital data may be directed towards and away from the DSLAM 3.

However, application of such a solution poses some difficulties. Indeed, wiring of the filtering rack 15 on the general frame 1 imposes the use of a long length of cables 15, 18, 21, not only inducing additional expenditure but also increasing the time required for laying and connecting them.

Further, the filtering rack 15 practically consisting of a cabinet incorporating different ADSL filters is rather bulky.

The present invention aims at providing a connector module with the use of which the cable length in a strip may be reduced by omitting the use of a filtering rack.

For this purpose, the present invention proposes a connector module including a housing, said housing including two parallel rows of contacts facing each other, whereby each of said contacts including a first terminal part for connection to a conductor and an opposite second terminal part, two successive contacts of a same row defining a pair of contacts, wherein each of said second terminal parts normally rests elastically against the second terminal part opposite, said module being characterized in that it includes a detachable card performing a function for electrical connection and low pass filtering of signals transmitted between said second terminal parts of at least one pair of contact of a row, a so-called first pair, and said second terminal parts of at least a pair of contacts on the other row, a so-called second pair, said detachable card including connection elements on each of the surfaces thereof, said connection elements establishing a connection between the opposite second terminal parts of each row by moving apart the second terminal parts which are normally in contact.

By means of the invention, the use of a filtering rack is no longer necessary as the filtering function may be directly integrated into the frame of the historical operator. By suppressing the filtering rack, a gain in wiring is obtained and therefore savings and simplification of the installation. The filter includes at least one low pass function with which the telephone voice data may be let through, while eliminating the noise at higher frequency.

The module according to the invention is installed in a strip and the connection between the strips is achieved via jumpers which are much more flexible to handle than cables; furthermore, placement of these jumpers may be adjusted according to demand.

Additionally, as normally each of the second terminal parts elastically rests against the second terminal part opposite, the card may be installed or removed from the module without cutting off the telephone conversation.

Advantageously, said first and second pairs of contacts are facing each other.

Advantageously, said first terminal parts for connection to a conductor, form the front of said housing and said card is pluggable through the rear part of said housing between said second terminal parts normally supported elastically and facing each other.

The wiring from the front on the first terminal parts is thus particularly simple as the detachable card is plugged at the rear and therefore does not interfere.

Advantageously, said detachable card performs at least one electrical connection function between the second terminal parts of the pair of contacts along said first pair on the same row and said second terminal parts of the pair of contacts facing said first pair on the other row.

With the card it is thereby possible to connect two pairs, each receiving one type of data (telephone vocal data and ADSL digital data, for example) to a same pair facing them.

Advantageously, said detachable card performs a high pass filter function between the second terminal parts of the pair of contacts along said first pair on the same row, and said second terminal parts of the pair of contacts facing said first pair on the other row.

This high pass filter enables low frequency noises to be filtered out as it only lets through ADSL digital data.

According to a particularly advantageous embodiment:
the first row includes 2n contact pairs forming n successive groups of two pairs of contacts, C₂ᵢ and C₂ᵢ₊₁ on the one hand and C′₂ᵢ and C′₂ᵢ₊₁ on the other hand, with i ranging from 0 to n−1, n being an integer larger than or equal to 1,
the second row includes at least 2 n contact pairs forming n successive groups of two pairs of contacts, C″₂ᵢ and C″₂ᵢ₊₁ on the one hand and C′″₂ᵢ and C′″₂ᵢ₊₁ on the other hand, the contacts C″₂ᵢ and C″₂ᵢ₊₁ facing the contacts C₂ᵢ and C₂ᵢ₊₁ and the contacts C′″₂ᵢ and C′″₂ᵢ₊₁ facing contacts C′₂ᵢ and C′₂ᵢ₊₁,
said card includes the first face including 2n pairs of connection elements forming successive groups of two pairs of connection elements, E₂ᵢ and E₂ᵢ₊₁ on the one hand, and E′₂ᵢ and E′₂ᵢ₊₁ on the other hand, with i ranging from 0 to n−1, and a second face including n pairs of connection elements E″₂ᵢ and E″₂ᵢ₊₁, so that when said card moves apart said second terminal parts which are normally in contact facing each other:
the connection elements E₂ᵢ and E₂ᵢ₊₁ will come into contact with the second terminal parts of the contacts C₂ᵢ and C₂ᵢ₊₁ respectively and the connection elements E′₂ᵢ and E′₂ᵢ₊₁ will come into contact with the second terminal parts of the contacts C′₂ᵢ and C′₂ᵢ₊₁ respectively,
the connection elements E″₂ᵢ and E″₂ᵢ₊₁, will come into contact with the second terminal parts of the contacts C″₂ᵢ and C″₂ᵢ₊₁ respectively,
   said connection elements E′₂ᵢ and E′₂ᵢ₊₁ being electrically connected to said connection elements E″₂ᵢ and E″₂ᵢ₊₁ via a low pass filter located on said card.

It is conceivable here that with the detachable card many groups of two pairs from a same row may be connected together. In such a case (n groups), n filter functions obviously need to be provided on the card.

Advantageously, said card includes 2n fingers cut out in said card forming n successive groups of two pairs of fingers, D₂ᵢ and D₂ᵢ₊₁ on the one hand and D′₂ᵢ and D′₂ᵢ₊₁ on the other hand, with i ranging from 0 to n−1, said fingers D₂ᵢ and D₂ᵢ₊₁ being metallized on each of said first and second faces of said card in order to form said connection elements E₂ᵢ and E₂ᵢ₊₁ on the one hand and E″₂ᵢ and E″₂ᵢ₊₁ on the other hand, and said fingers D′₂ᵢ and D′₂ᵢ₊₁ being exclusively metallized on said first face of said card so as to form said connection elements E′₂ᵢ and E′₂ᵢ₊₁.

Advantageously, said connection elements E′₂ᵢ and E′₂ᵢ₊₁ are electrically connected to said connection elements E″₂ᵢ and E″₂ᵢ₊₁.

Advantageously, said electrical connection is achieved via a high pass filter.

Advantageously, at least one pair of contacts is electrically connected to the opposite contact pair via a jumper element providing an electrical connection between the first terminal parts of the opposite contacts.

According to one embodiment, said first terminal parts are suitable for receiving a conductor winding of the “wrapping” type.

According to another embodiment, said first terminal parts include a self-stripping slit.

The object of the present invention is also a connection strip including a plurality of connector modules according to the invention.

Advantageously, said strip includes a support incorporating said plurality of strips, said support being rotatably mounted around an axis of rotation.

Finally, the object of the present invention is a connector strip including a substantially rectangular attachment plate including a first face on which are removably attached a plurality of modules according to the invention, said housing of each of said modules including on its rear part, means for attaching said module on said first face, said modules being positioned in a row along a first direction, parallel with each other so that said first terminal part for connection to a conductor are apparent on one face, a so-called front face, of said strip, the attachment plate having a plurality of slits showing said second terminal parts so that said cards are pluggable through the second face of said plate via said slits.

Advantageously, said attachment plate is rotatably mounted around an axis of rotation substantially extending along one side of said plate.

Advantageously, the strip according to the invention includes an attachment block as a half rectangular parallelepiped, the first rectangular support of which is intended to be mounted against a supporting element such as a wall and the second rectangular support includes on its longitudinal side elements for holding said plate in rotation.

Other features and advantages of the present invention will become apparent in the following description of an embodiment of the invention, given as an illustration and by no means limitedly.

In the following figures:

FIG. 1 schematically illustrates an ADSL architecture according to the state of the art,

FIG. 2 illustrates a connector module according to the invention,

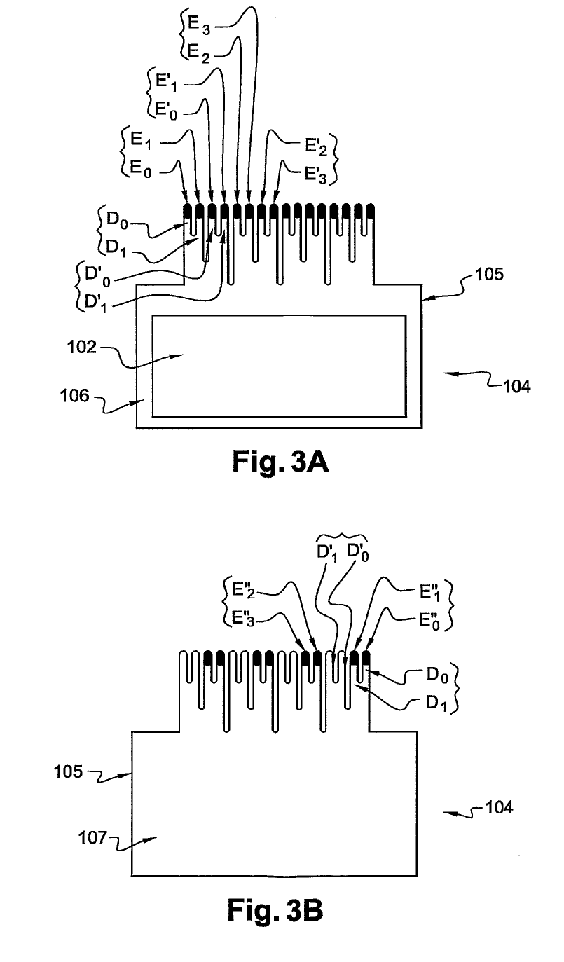

FIG. 3A illustrates a view along a first face of a detachable card used in the module of FIG. 2,

FIG. 3B illustrates a view along a second face of the detachable card used in the module of FIG. 2,

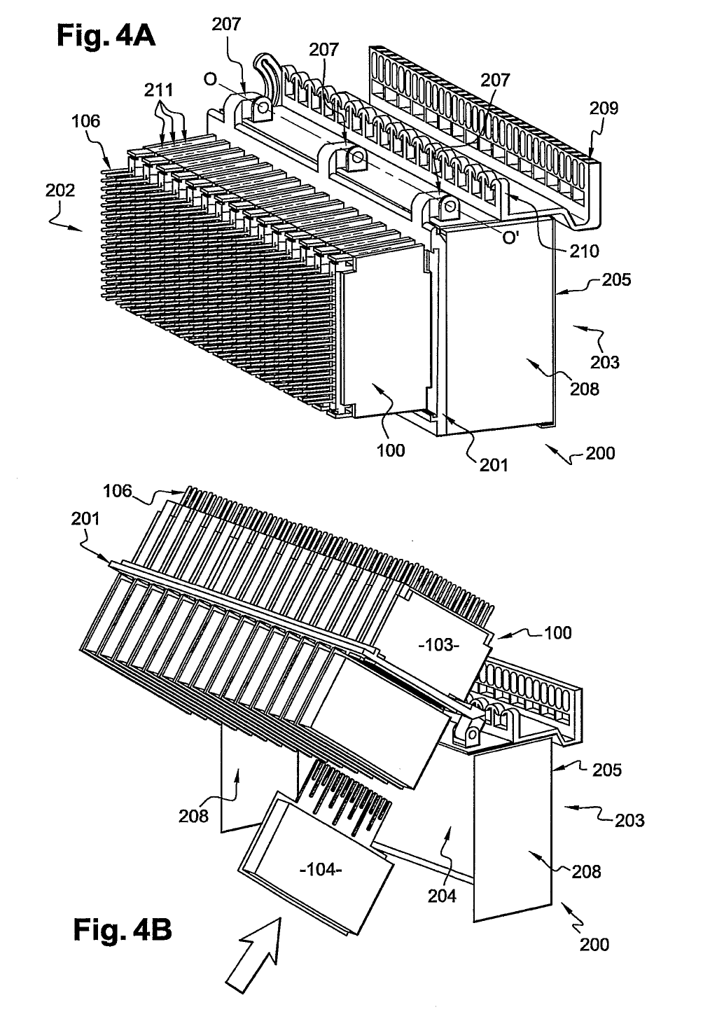

FIG. 4A illustrates a connector strip according to the invention in a closed state,

FIG. 4B illustrates a connector strip according to the invention in an open state,

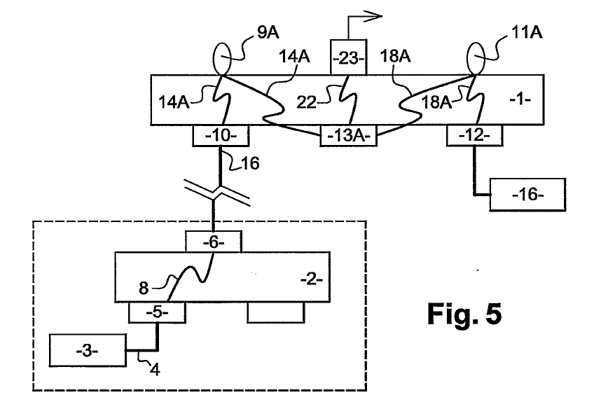

FIG. 5 schematically illustrates an ADSL architecture using a connector strip according to the invention.

FIG. 1 has already been described in connection with the state of the art.

FIG. 2 illustrates a connector module 100 according to the invention.

The connector module 100 includes:
a block 103, a so-called cut-off block,
a detachable card 104, a so-called filter card.

The cut-off block 103 includes a housing 108 in which are confined two parallel rows of contacts, R1 (first row) and R2 (second row), facing each other from one row to the other.

Generally, in all the following description, each contact includes:
a first terminal part 106 for receiving a conductor winding of the wrapping type (let us note that this may also be a self-stripping fork),
a second terminal part 107 in the shape of an arcuate connection tail for its elastic pressure connection with the connection tail of an analogous contact opposite.

The cut-off block 103 therefore has a so-called front face through which the first terminal parts 106 are accessible, and a so-called rear face through which face the second terminal parts 107 are accessible.

The first row R1 includes 2n (n=4 here) contact pairs forming n successive groups of two pairs of contacts, C₂ᵢ and C₂ᵢ₊₁ on the one hand, and C′₂ᵢ and C′₂ᵢ₊₁ on the other hand, with i ranging from 0 to n−1.

As an example, the first group illustrated in FIG. 1 includes the contacts C₀ and C₁ on the one hand, and the contacts C′₀ and C′₁ on the other hand.

The second row R2 includes 2n contact pairs forming n successive groups of two pairs of contacts, C″₂ᵢ and C″₂ᵢ₊₁ on the one hand, C′″₂ᵢ and C′″₂ᵢ₊₁ on the other hand, the contacts C″₂ᵢ and C″₂ᵢ₊₁ facing the contacts C₂ᵢ and C₂ᵢ₊₁ and the contacts C′″₂ᵢ and C′″₂ᵢ₊₁ facing the contacts C′₂ᵢ and C′₂ᵢ₊₁.

As an example, the first group illustrated in FIG. 1 includes the contacts C″₀ and C″₁ (facing C₀ and C₁, respectively) on the one hand and the contacts C′″₀ and C′″₁ (facing C′₀ and C′₁, respectively) on the other hand. The filter card will be better understood with reference to FIGS. 3A and 3B illustrating a view of both faces 106 and 107 of the card 104, respectively.

The filter card 104 includes:
filtering means 102 located on its first face 106,
a printed circuit support 105.

The card 104 further includes 2n fingers cut out in the card forming n successive groups of two pairs of fingers, D₂ᵢ and D₂ᵢ₊₁ on one hand, and D′₂ᵢ and D′₂ᵢ₊₁ on the other hand, with i ranging from 0 to n−1.

The fingers D₂ᵢ and D₂ᵢ₊₁ are metallized on each of the first and second faces 106 and 107 of the card 104 in order to form connection elements E₂ᵢ and E₂ᵢ₊₁ on the one hand (on the first face 106) and E″₂ᵢ and E″₂ᵢ₊₁ on the other hand (on the second face 107).

The fingers D′₂ᵢ and D′₂ᵢ₊₁ are exclusively metallized on the first face 106 so as to form connection elements E′₂ᵢ and E′₂ᵢ₊₁.

As an example, the fingers D₀ and D₁ on the one hand and D′₀ and D′₁ on the other hand are illustrated in FIGS. 3A and 3B.

The fingers D₀ and D₁ are metallized on each of the faces 106 and 107 whereas the fingers D′₀ and D′₁ are exclusively metallized on the face 106.

The connection elements E₂ᵢ and E₂ᵢ₊₁ of the face 106 are electrically connected to the connection elements E″₂ᵢ and E″₂ᵢ₊₁ of the face 107 via a low pass filter located in the filtering means 102 and produced in a known way. Let us note here that the electrical connection between the connection elements E₂ᵢ and E₂ᵢ₊₁ and the filtering means 102 was omitted for the sake of clarity of the illustration.

The connection elements E′₂ᵢ and E′₂ᵢ₊₁ of the face 106 are electrically connected to the connection elements E″₂ᵢ and E″₂ᵢ₊₁ of the face 107. This electrical connection may be achieved via a high pass filter located in the filtering means 102.

When the filter card is introduced through the rear face of the block 103, the card moves apart, via its fingers, the second terminal parts normally in elastic contact, so that:
the connection elements E₂ᵢ and E₂ᵢ₊₁ come into contact with the second terminal parts of contacts C₂ᵢ and C₂ᵢ₊₁ respectively and the connection elements E′₂ᵢ and E′₂ᵢ₊₁ come into contact with the second terminal parts of the contacts C′₂ᵢ and C′₂ᵢ₊₁ respectively,
the connection elements E″₂ᵢ and E″₂ᵢ₊₁, come into contact with the second terminal parts of the contact EC₂ᵢ and C″₂ᵢ₊₁, respectively.

In the case of an ADSL connection, two types of data may be received: telephone data using low frequencies and high rate digital data at a higher frequency.

At the strip, the telephone data are received on contacts C₂ᵢ and C₂ᵢ₊₁ and high frequency digital data are received on contacts C′₂ᵢ and C′₂ᵢ₊₁.

Both telephone data and the digital data are transmitted towards the contacts C″₂ᵢ and C″₂ᵢ₊₁.

When the card 104 is inserted into the block 103, the telephone data are filtered so as to remove higher frequency noise.

Also, in the presence of high pass filters in the filtering means 102, the high frequency digital data are filtered so as to remove the low frequency noise.

In the absence of these high pass filters, the digital data are transmitted without any filtering towards the contacts C″₂ᵢ and C″₂ᵢ₊₁.

Let us note that when the filter card 104 is removed (in this case suppression of the ADSL connection), a telephone conversation is not cut off as the facing contacts again find their initial position in elastic contact.

Let us further note that we have considered the contacts for telephone data C₂ᵢ and C₂ᵢ₊₁ facing the line contacts EC₂ᵢ and C″₂ᵢ₊₁ in our example but we might just have well considered the high frequency data on the contacts C₂ᵢ and C₂ᵢ₊₁ . In such a case the low pass filtering function may be achieved with the card 104 between the contacts C′₂ᵢ and C′₂ᵢ₊₁ and C″₂ᵢ and C″₂ᵢ₊₁.

The use of a jumper on the front face connecting the first terminal part of a contact pair to first terminal parts of a facing pair of contacts may also be contemplated so that said pairs of contacts are electrically connected via the jumper and independently of the filter card 104. This type of jumper allows different combinations on the metallizations of the filter card: transmission of high frequency data may notably be achieved, from a pair of contacts to the facing contact pair via the jumper and the ADSL connection may be cut off by simply removing the jumper. With such a solution, the data may be received on one row or the other.

FIGS. 4A and 4B illustrate a strip 200 according to the invention in a closed state and in an open state, respectively.

The strip 200 includes an attachment plate 201 including a first face on which 16 connector modules 100 are removably attached as illustrated in FIG. 2 and positioned parallel to each other so that the first terminal parts 106 for connecting to a conductor of the module 100 are apparent on the front face 202 of the strip 200.

The attachment plate 201 has 16 slits, not visible in the figure, showing the second terminal parts, also not visible in the figure, so that the filter cards 104 are plugged into the cut-off block 103 via each of the 16 slits. In other words, the attachment plate 201 is found inserted between the cut-off block part 103 and the filter card part 104 of each of the connector modules 100.

The strip 200 further includes an attachment block in the shape of a half rectangular parallelepiped including:
a first longitudinal rectangular support 204 attached by its side 205 against a supporting element such as a wall via attachments not shown,
a second longitudinal rectangular support 206 perpendicular to the support 204 and including attachment elements 207 of the plate 201 on the second support 204,
third and fourth side supports 208.

The attachment elements 207 are such that the plate 201 is rotatably mounted around a horizontal axis OO′.

Thus, when a filter card 104 needs to be added or changed, it is sufficient to tilt (by rotation around OO′) the plate 201 upwards as illustrated in FIG. 4B and to place the filter card by plugging in it between the second terminal parts of the corresponding connection block. The strip 200 is then closed again and is in an operating state.

It should be noted that with such a strip architecture, the strip fixed against the wall may be held even when the filter cards are replaced; the wiring may be made through the front face of the strip on the other hand, without the filter cards interfering since the latter are inserted from the rear (second terminal parts) of the connector modules.

Let us also note that the strip 200 may comprise different types of guiding means 209 and 210 for the passage of data cables and/or jumpers towards the connection inputs 211 of the connector module 100.

The horizontal axis of rotation OO′ is substantially placed perpendicularly and close to the path of the cables from these guiding means in order to minimize, or even cancel the stresses on the wires during the rotation.

FIG. 5 schematically illustrates an ADSL architecture using a connector strip 13A according to the invention such as the strip 200 illustrated in FIGS. 4A and 4B.

This architecture is identical with the ADSL architecture illustrated in FIG. 1 with the difference that:
the connector strip 13 and the filter rack 15 illustrated in FIG. 1 are replaced with the connector strip 13A according to the invention,
the strips 9 and 11 of the vertical side of the frame 1 of FIG. 1 are replaced with rings 9A and 11A. Such architecture provides a reduction in the total cost as the cables 17 and 18 of FIG. 1 are replaced with jumpers 14A and 18A. This cost reduction appears not only as regards the gained cable length but also as regards the time required for placing and connecting the cable.

Further, the jumpers, 14A and 18A, passing through the rings 9A and 11A respectively and replacing the cables 17 and 18, provide an adjustable placement according to demand.

Finally, with such an architecture, the bulkiness may be reduced to the extent that two connector strips on the vertical side of the frame as well as an ADSL filter rack are suppressed.

Of course, the invention is not limited to the embodiment which has just been described.

Notably, the filter card was described as having exactly the same number of connections as the connector module; thus, a single card corresponds to a single cut-off block. However, a connector module may also be contemplated with several filter cards inserted from the rear and providing different filtering functions on between the contacts of the module.

Also, the module and the strip according to the invention have more particularly been described in the case of an ADSL connection, but it is also conceivable that they be used for exchanging types of data other than telephone data and higher frequency data.

1. A connector module comprising:
a housing, said housing including two parallel rows of contacts facing each other from one row to another, each of said contacts including a first terminal part for connection to a conductor and an opposite second terminal part, two successive contacts of a same row defining a pair of contacts, wherein normally each of said second terminal parts rests elastically against the second terminal part opposite, said module having a detachable card providing an electrical connection and low pass filtering function for signals transmitted between said second terminal parts of at least one pair of contacts of a row, a so-called first row, and said second terminal parts of at least one pair of contacts on the other row, a so-called second pair, said detachable card including connection elements on each of its faces, said connection elements establishing the connection between the opposite second terminal parts of each row by moving apart the second terminal parts which are normally in contact.

2. The connector module according to claim 1, wherein said first and second pairs of contacts are facing each other.

3. The connector module according to claim 1, wherein said first terminal parts for connection to a conductor form the front part of said housing and in that said card is pluggable through the rear part of said housing between said second terminal parts normally resting elastically and facing each other.

4. The connector module (100) according to claim 2, wherein said detachable card provides at least one function for electrical connection between the second terminal parts of the pair of contacts along said first pair on the same row and said second terminal parts of the contact pair facing said first pair on the other row.

5. The connector module according to the preceding claim, wherein said detachable card provides a high pass filter function between the second terminal parts of the pair of contacts along said first pair on the same row and said second terminals parts of the contact pair facing said first pair on the other row.

6. The connector module according to the preceding claim, wherein:
the first row includes 2n contact pairs forming n successive groups of two pairs of contacts, C₂ᵢ and C₂ᵢ₊₁ on the one hand and C′₂ᵢ and C′₂ᵢ₊₁ on the other hand, with i ranging from 0 to n−1, n being an integer larger than or equal to 1,
the second row includes at least 2n contact pairs forming n successive groups of two pairs of contacts, C″₂ᵢ and C″₂ᵢ₊₁ on the one hand and C′″₂ᵢ and C′″₂ᵢ₊₁ on the other hand, the contacts C″₂ᵢ and C″₂ᵢ₊₁ facing the contacts C₂ᵢ and C₂ᵢ₊₁ and the contacts C′″₂ᵢ and C′″₂ᵢ₊₁ facing contacts C′₂ᵢ and C′₂ᵢ₊₁,
said card includes the first face including 2n pairs of connection elements forming n successive groups of two pairs of connection elements, E₂ᵢ and E₂ᵢ₊₁ on the one hand and E′₂ᵢ and E′₂ᵢ₊₁ on the other hand, with i ranging from 0 to n−1, and a second face including n pairs of connection elements E″₂ᵢ and E″₂ᵢ₊₁, so that said card moves apart said second terminal parts normally in contact each other:
the connection elements E₂ᵢ and E₂ᵢ₊₁ come into contact with the second terminal parts of the contacts C₂ᵢ and C₂ᵢ₊₁ respectively and the connection elements E′₂ᵢ and E′₂ᵢ₊₁ come into contact with the second terminal parts of the contacts C′₂ᵢ and C′₂ᵢ₊₁ respectively,
the connection elements E″₂ᵢ and E″₂ᵢ₊₁, come into contact with the second terminal parts of the contacts C″₂ᵢ and C″₂ᵢ₊₁ respectively,
said connection elements E′₂ᵢ and E′₂ᵢ₊₁ being electrically connected to said connection elements E″₂ᵢ and E″₂ᵢ₊₁ via a low pass filter located on said card.

7. The connector module according to the preceding claim, wherein said card includes 2n fingers cut out in said card forming n successive groups of two pairs of fingers, D₂ᵢ and D₂ᵢ₊₁ on the one hand, and D′₂ᵢ and D′₂ᵢ₊₁ on the other hand, with i ranging from 0 to n−1, said fingers E₂ᵢ and E₂ᵢ₊₁ being metallized on each of said first and second faces of said card so as to form said connection elements E₂ᵢ and E₂ᵢ₊₁ on the one hand and E″₂ᵢ and E″₂ᵢ₊₁ on the other hand, and said fingers D′₂ᵢ and D′₂ᵢ₊₁ being exclusively metallized on said first face of said card so as to form said connection elements E′₂ᵢ and E′₂ᵢ₊₁.

8. The connector module according to claim 6, wherein said connection elements E′₂ᵢ and E′₂ᵢ₊₁ are electrically connected to said connection elements E″₂ᵢ and E″₂ᵢ₊₁.

9. The connector module according to the preceding claim, wherein said electrical connection is achieved via a high pass filter.

10. The connector module according to claim 1, wherein at least one pair of contacts is electrically connected to the opposite contact pair via a jumper element providing an electrical connection between the first terminal parts of the contacts facing each other.

11. The connector module according to claim 1, wherein said first terminal parts are adapted in order to receive a conductor winding.

12. The connector module according to claim 1, wherein said first terminal parts include a self-stripping slit.

13. A connector strip including a plurality of connector modules according to claim 1.

14. The connector strip according to the preceding claim, wherein it includes a support incorporating said plurality of strips, said support being rotatably mounted around an axis of rotation.

15. The connector strip including a substantially rectangular attachment plate including a first face on which a plurality of connector modules according to claim 3 are removably attached, said housing on each of said modules including on its rear part, means for attaching said module onto said first face, said modules being arranged as a row along a first direction, parallel with each other so that said first terminal parts for connection to a conductor are apparent on one face, the so-called front face, of said strip, the attachment plate having a plurality of slits showing said second terminal parts so that said cards are pluggable through the second face of said plate via said slits.

16. The connector strip according to the preceding claim, wherein said attachment plate is rotably mounted around an axis of rotation (OO′) substantially extending along one side of said plate.

17. The connector strip according to claim 16, wherein it includes an attachment block in the shape of a half rectangular parallelepiped, the first rectangular support of which is intended to be mounted against a supporting element such as a wall and the second rectangular support includes on its longitudinal side elements for rotatably holding said plate.
